(19) United States
(12) Patent Application Publication
(10) Pub. No.: US 2015/0014580 A1
(43) Pub. Date: Jan. 15, 2015

(54) ETCHING LIQUID FOR FORMING TEXTURE

(71) Applicant: DAI-ICHI KOGYO SEIYAKU CO., LTD., Kyoto-shi, Kyoto (JP)

(72) Inventors: Kazunori Nakagawa, Kyoto (JP); Shigeru Kigasawa, Kyoto (JP); Toshikazu Nabeshima, Kyoto (JP)

(73) Assignee: DAI-ICHI KOGYO SEIYAKU CO., LTD., Kyoto-shi, Kyoto (JP)

(21) Appl. No.: 14/376,692

(22) PCT Filed: Feb. 6, 2013
(86) PCT No.: PCT/JP2013/052663

§ 371 Date: Aug. 5, 2014

(30) Foreign Application Priority Data
Feb. 8, 2012 (JP) 2012-025387

(51) Int. Cl. C09K 13/02

(52) U.S. Cl. CPC C09K 13/02
USPC 252/79.5

(57) ABSTRACT

In the present invention, by using an etching liquid for silicon wafers, which comprises an aqueous solution containing (A) an alkali component and (B) a phosphonic acid derivative or a salt thereof, a good texture can be stably and uniformly formed on a wafer surface. The present invention provides a texture-forming etching liquid for silicon wafers, which is applicable to both wafers cut by a loose abrasive grain system and wafers cut by a fixed abrasive grain system with no vaporization of additive components in the region of working temperatures of from 60° C. to 95° C.

### TECHNICAL FIELD

The present invention relates to an etching liquid for forming a relief structure, which is called a texture, on the surface of a silicon substrate.

### TECHNICAL FIELD

A crystalline silicon substrate for use in solar cells is given surface structure treatment called texturing for reducing the light reflectance on the substrate surface to secure efficient light absorption.

Heretofore, it has been used a method for forming a pyramid-like textured structure by dipping a silicon substrate in an alkaline solution of sodium hydroxide, potassium hydroxide or the like, and it is known that a more uniform pyramid-like textured structure can be formed by using any other additive than the alkali component in the etching liquid.

As such a texture-forming etching liquid, it is known an aqueous solution of sodium hydroxide or potassium hydroxide with isopropyl alcohol (IPA) added thereto, for example, as described in Patent Literature 1. When it is used, a texture is formed by dipping a silicon wafer therein for 10 to 30 minutes under a heating condition at from 60 to 95° C.

The above-mentioned IPA is widely recognized as an additive for forming a pyramid-patterned texture on a silicon wafer, and makes it possible to finish the wafer with good quality. However, since the boiling point of IPA is 82.4° C. and is on the same level as the temperature of etching treatment, there is a problem that IPA vaporizes during treatment and the etching liquid composition tends to be thereby changed. In addition, since the ignition point thereof is low, IPA must be handled with care.

Consequently, various other additives than IPA have been proposed for forming good textures through addition thereof to an alkali etching liquid. However, at present, etching liquids and additives which are comprehensively satisfactory in the point that they are excellent in texture formation and that their quality management for concentration control or the like in using them is easy has not been obtained (Patent Literatures 2 to 6).

Recently, the slicing system for silicon wafers has been changed from the already-existing loose abrasive grain system to a fixed abrasive grain system, and in these systems, the sliced wafers differ in the surface condition thereof. Consequently, there is a problem in that the etching liquid that is usable in the already-existing loose abrasive grain system could not be used in a fixed abrasive grain system directly as it is.

### PRIOR ART PUBLICATIONS

### Patent Literature

Patent Literature 1: JP-A-2000-183378

Patent Literature 2: W02007/129555

Patent Literature 3: JP-A-2009-123811

Patent Literature 4: JP-A-2002-57139

Patent Literature 5: JP-A-2007-258656

Patent Literature: JP-A-2010-141139

### SUMMARY OF INVENTION

### Problem to be Solved

The present invention has been made in consideration of the above-mentioned problems, and its object is to provide a texture-forming etching liquid for silicon wafers, which can form uniformly and stably a good texture on a wafer surface and which is applicable to both wafers cut by a loose abrasive grain system and wafers cut by a fixed abrasive grain system with no vaporization of additive components in the region of a working temperature of from 60° C. to 95° C.

### Means for Solving the Problem

For solving the above-mentioned problems, the inventors of the present invention have assiduously studied and, as a result, have found that an alkali liquid containing a phosphonic acid derivative is excellent in forming a pyramid-like textured-structure as an etching liquid for silicon wafers, and have accomplished the present invention.

Namely, an etching liquid of the present invention is an etching liquid for forming a texture on the surface of a silicon substrate, and it comprises an aqueous solution containing (A) an alkali component and (B) a phosphonic acid derivative or a salt thereof in order to solve the above problem.

In the above etching liquid of the present invention, as most preferable alkali component, sodium hydroxide or potassium hydroxide can be used.

Additionally, it is preferable that the concentration of the alkali component is from 0.3% by mass to 25% by mass.

Additionally, it is preferable that the concentration of the phosphonic acid derivative or its salt is from 0.1% by mass to 25% by mass.

Furthermore, the blend ratio of the alkali component (A) to the phosphonic acid derivative or its salt (B) is from 0.1 to 10 as A/B by mass.

### Mode for Carrying out Invention

The present invention is described in detail hereinunder.

The alkali component for use in the invention is not specifically defined, and any one heretofore used in an etching liquid for silicon wafers is appropriately usable here. Its examples include alkali metal or alkaline earth metal hydroxides or their salts such as sodium hydroxide, potassium hydroxide, etc. Sodium hydroxide is preferred as generally easily available. If desired, two or more of these alkali components may be used here as combined.

Next, the phosphonic acid derivative to be used as an additive in the invention is not specifically defined, and may be any one generally usable in the art as a metal ion sequestering agent.

Preferred examples of the phosphonic acid derivative include 1-hydroxyethylene-1,1-diphosphonic acid represented by the following formula (1), nitrilotris(methylenephosphonic acid) represented by the following formula (2), phosphonobutane tricarboxylic acid represented by the following formula (3), alkylenediamine tetra(methylenephosphonic acid) represented by the following formula (4) (for example, in the formula (4), ethylenediamine tetra(methylenephosphonic acid) where n=2, hexamethylenediamine-tetra(methylenephosphonic acid) where n=6, etc.), dialkylenetriamine penta(methylenephosphonic acid) represented by the following general formula (5) (for example, in the formula (5), diethylenetriamine pneta(methylenephosphonic acid) where n=2, etc.), and their salts. Examples of their salts include alkali metal salts, alkaline earth metal salts, amine salts and ammonium salts. Preferably used are alkali metal salts such as sodium salts, potassium salts and others, since they are generally easily available. If desired, two or more of those phosphonic acid derivatives may be used here in combination.

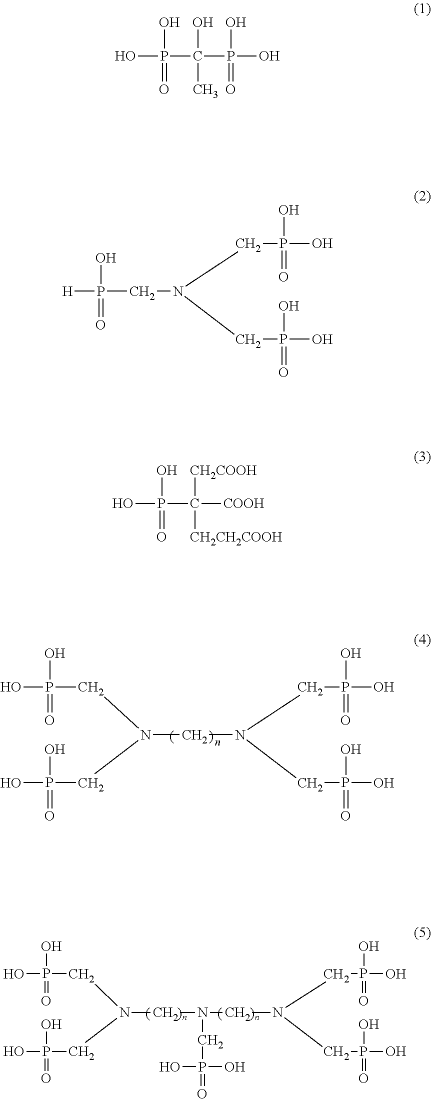

Of the above-mentioned phosphonic acid derivatives, 1-hydroxyethylene-1,1-diphosphonic acid, nitrilotris(methylenephosphonic acid) or phosphonobutane-tricarboxylic acid are especially preferable, from the viewpoint that the uniformity of the textured structure to be obtained is high and high-purity products containing few impurities which is undesired in the present use are easy to obtain.

The etching liquid of the invention is an aqueous solution of the above-mentioned alkali component and phosphonic acid derivative dissolved in water. Water to be used here is preferably one from which impurities have been removed, such as ion-exchanged water or distilled water.

In the etching liquid of the invention, namely, in the above-mentioned aqueous solution, the concentration of the alkali component is preferably within a range of from 0.3% by mass to 25% by mass, more preferably from 1% by mass to 15% by mass. When the concentration of the alkali component is less than 0.3% by mass, then the etching power would be poor and much time would be taken in texture formation; while when the concentration is more than 25% by mass, the necessary amount of the etching inhibitor to be used as an additive would increase which cause to be costly.

The content of the phosphonic acid derivative in the etching liquid is preferably from 0.1% by mass to 25% by mass, more preferably from 0.5% by mass to 15% by mass. When the content of the phosphonic acid derivative is less than 0.1% by mass, there is possibility that the sufficient effect of inhibiting alkali etching cannot be obtained; while when the content is more than 25% by mass, the alkali etching would be too much inhibited and there is possibility that too much time is necessary in texture formation.

Further, for forming a better texture, it is desirable that the ratio of the content of the phosphonic acid derivative to the content of the alkali component is controlled. Preferably, the blend ratio of the alkali component (A) to the phosphonic acid derivative (B) falls, within a range of from 0.5 to 10 as A/B by mass, and more preferably, A/B is from 1 to 5. It is considered that, by controlling the ratio of the two to fall within the above range, the anisotropic etching of silicon by the alkali component could be suitably controlled by the phosphonic acid derivative, which contributes toward good texture formation.

When the amount of the phosphonic acid derivative relative to the alkali component is too small, the etching inhibiting effect would be poor and the etching rate would increase and, as a result, it would be difficult to control the profile and the size of the textured structure and the surface tends to be ununiform.

On the other hand, when the amount of the phosphonic acid derivative relative to the alkali component is too large, then the etching inhibiting effect would be too great so that the etching rate would lower and a textured structure could not be formed.

Within a range which is not contradictory to the object of the present invention, any additives such as isopropyl alcohol, fatty acid and the like which are generally usable in a texture-forming etching liquid for silicon wafers may be optionally added to the etching liquid of the present invention.

In a case of wafers which is cut according to an already-existing loose abrasive grain system, even though a suitable texture can be formed on the wafer by using an etching liquid prepared for obtaining the intended performance, when the etching liquid is applied to the wafers cut according to a fixed abrasive grain system directly as it is, the same suitable texture could not always be formed. For this, various reasons could be taken into consideration. For example, the sliced wafers differ in point of the cutting trace on the wafer surface, or the coolant used in slicing differs and therefore the coolant residue would have any influence on the wafers owing to the washing failure in the subsequent washing step. Contrary to these, in case where the etching liquid of the present invention is used, the phosphonic acid derivative therein can regularly align on both the surfaces of the silicon wafers cut according to a loose abrasive grain system and those of the silicon wafers according to a fixed abrasive grain system owing to the excellent adsorbing power of the phosphonic acid derivative, and therefore the alkali etching by the etching liquid of the present invention can be thereby appropriately controlled. For these reasons, the etching liquid of the present invention is applicable to both wafers cut according to a loose abrasive grain system and according to a fixed abrasive grain system.

The etching method using the etching liquid of the present invention is not specifically limited. A method that comprises heating the etching liquid at about 60° C. to 95° C., and dipping the targeted silicon wafers therein for 10 to 30 minutes, like in conventional methods can be used.

By using the etching liquid of the present invention, it is possible to form a uniform pyramid-like textured structure on the surface of a silicon substrate. Within the region of a working temperature of from 60° C. to 95° C., the additive component does not vaporize, and therefore a stable texture can be formed and the safety is high. Further, the etching liquid of the present invention is applicable to both wafers cut by a loose abrasive grain system and wafers cut by a fixed abrasive grain system. Consequently, by using the etching liquid of the present invention, it becomes possible to stably supply high-quality silicon wafers capable of enhancing the performance of solar cells.

### EXAMPLES

The present invention is described more specifically according to Examples. However, the invention is not limited to the following Examples.

### Examples, Comparative Examples

Sodium hydroxide and a phosphonic acid derivative or a salt thereof are mixed in the ratio shown in Table 1, and ion-exchanged water was added thereto to prepare an aqueous solution. This is the etching liquid of the present invention. The etching liquid was heated to be 80° C., and single-crystal silicon wafers cut according to any of a loose abrasive grain system or a fixed abrasive grain system shown in Table 1 were dipped in the liquid for 20 minutes, then washed with water and dried. The textured structure of the obtained silicon wafers was evaluated for the following two items.

### (1) Appearance Evaluation of Textured Structure

By using a scanning electronic microscope (JEOL's JSM-6380LV), the textured structure was observed. In observation at a power of 1000 magnifications, the samples in which a pyramid-like structure was formed on the substrate surface so that the flat region of the substrate with no pyramids thereon could be at most 5% of all the surface area were evaluated as good (O), and the samples in which a flat region covered over 5% of all the surface area were evaluated as not good (x).

### (2) Reflectance Evaluation of Silicon Substrate

The reflectance of the silicon substrate was measured with a UV/visible light spectrophotometer (Hitachi High-Technologies' U-3900H). The samples of which the reflectance of light having a wavelength of 600 nm was 13% or less were evaluated as good (O) and the samples of which the reflectance was larger than 13% were evaluated as not good (x).

TABLE 1

| | | | | | | | Evaluation results | |
|---|---|---|---|---|---|---|---|---|
| | | | | | | | (1) | (2) Reflectance |
| | | (A) Alkali Component | | (B) Phosphonic Acid Derivative | | | Evaluation | evaluation of silicon |
| | | | Concen- | | Concen- | | of textured | substrate Value |
| | | Compound | tration | Compound | tration | | structure | of reflectance/ |
| | | name | (mass %) | name | (mass %) | Type of Wafer | appearance | evaluation |
| Example | 1 | Sodium | 0.5 | 1-hydroxyethylene-1,1- | 0.2 | Loose abrasive grain system | ∘ | 12.2%/∘ |
| | 2 | hydroxide | 1 | diphosphonic acid | 0.3 | Loose abrasive grain system | ∘ | 12.5%/∘ |
| | 3 | | 1 | | 2 | Loose abrasive grain system | ∘ | 12.1%/∘ |
| | 4 | | 3 | | 0.5 | Loose abrasive grain system | ∘ | 12.5%/∘ |
| | 5 | | 3 | | 1 | Loose abrasive grain system | ∘ | 11.6%/∘ |
| | 6 | | 3 | | 2 | Loose abrasive grain system | ∘ | 11.8%/∘ |
| | 7 | | 3 | | 15 | Loose abrasive grain system | ∘ | 12.8%/∘ |
| | 8 | | 5 | | 3 | Loose abrasive grain system | ∘ | 12.1%/∘ |
| | 9 | | 5 | | 3 | Fixed abrasive grain system | ∘ | 12.8%/∘ |
| | 10 | | 5 | | 6 | Loose abrasive grain system | ∘ | 12.2%/∘ |
| | 11 | | 10 | | 3 | Loose abrasive grain system | ∘ | 11.4%/∘ |
| | 12 | | 10 | | 6 | Loose abrasive grain system | ∘ | 11.5%/∘ |
| | 13 | | 5 | Nitrilotris | 2 | Loose abrasive grain system | ∘ | 12.8%/∘ |
| | 14 | | 5 | (methylenephosphonic acid) | 2 | Fixed abrasive grain system | ∘ | 12.9%/∘ |
| | 15 | | 5 | phosphonobutane- | 1 | Loose abrasive grain system | ∘ | 12.8%/∘ |
| | 16 | | 5 | tricarboxylic acid | 1 | Fixed abrasive grain system | ∘ | 12.9%/∘ |
| | 17 | | 5 | | 3 | Loose abrasive grain system | ∘ | 12.6%/∘ |
| | 18 | Potassium | 5 | 1-hydroxyethylene-1,1- | 3 | Loose abrasive grain system | ∘ | 12.5%/∘ |
| | | hydroxide | | diphosphonic acid | | | | |
| Compar- | 1 | Sodium | 5 | none | — | Loose abrasive grain system | x | 22.8%/x |
| ative | | hydroxide | | | | | | |
| Example | 2 | Sodium | 5 | none | — | Fixed abrasive grain system | x | 24.4%/x |
| | | hydroxide | | | | | | |

### INDUSTRIAL APPLICABILITY

The etching liquid of the present invention is usable for etching silicon substrates of solar cells, etc.

The present application is based on a Japanese patent application filed on Feb. 8, 2012 (Patent Application 2012-025387), the contents of which are herein incorporated by reference.

1. An etching liquid for forming a texture on the surface of a silicon substrate, which comprises:
an aqueous solution containing (A) an alkali component and (B) a phosphonic acid derivative or a salt thereof.

2. The etching liquid according to claim 1, wherein the alkali component is sodium hydroxide or potassium hydroxide.

3. The etching liquid according to claim 1, wherein the concentration of the alkali component is from 0.3% by mass to 25% by mass.

4. The etching liquid according to claim 2, wherein the concentration of the alkali component is from 0.3% by mass to 25% by mass.

5. The etching liquid according to claim 1, wherein the concentration of the phosphonic acid derivative or its salt is from 0.1% by mass to 25% by mass.

6. The etching liquid according to claim 1, wherein the blend ratio of the alkali component (A) to the phosphonic acid derivative or its salt (B) is from 0.1 to 10 as A/B by mass.
